(19) United States
(12) Patent Application Publication
(10) Pub. No.: US 2023/0164288 A1
(43) Pub. Date: May 25, 2023

(54) Device for Hanging a TV, Display Screen, or Other Electronic Displays

(71) Applicants: Justin Engel, Henderson, NV (US); Harry Michael Engel, Palmdale, CA (US)

(72) Inventors: Justin Engel, Henderson, NV (US); Harry Michael Engel, Palmdale, CA (US)

(21) Appl. No.: 17/991,639

(22) Filed: Nov. 21, 2022

Related U.S. Application Data
(60) Provisional application No. 63/281,107, filed on Nov. 19, 2021.

(51) Int. Cl. H04N 5/655

(52) U.S. Cl. CPC H04N 5/655

(57) ABSTRACT

The three components are combined to create a device for hanging a TV, display screen, or other electronic display. A ring terminal is crimped on to each opposing end of a 1.5 mm wire. Ring terminals are sized to fit the bolts and horizontal length of the mounting holes on the back of a TV, display screen, or other electronic display. A length of wire longer than the horizontal distance between two points on the back of a TV, display screen, or other electronic display is used to create a partial loop. Ring terminal ends are sized to self-tapping screws or screws provided by the case or manufacturer mounts are used to attach the ring terminals and the associated wire to the TV, display screen, or other electronic display for hanging on a single hook, screw, or other receiving appending on a wall.

### FEDERALLY SPONSORED RESEARCH

Not Applicable

### SEQUENCE LISTING OR PROGRAM

Not Applicable

### TECHNICAL FIELD OF THE INVENTION

The present invention relates generally to hanging displays. More specifically, the present invention relates to using existing portions of a television or other electronic display typically constructed of a plastic housing on a wall to hang the display with a wire.

### BACKGROUND OF THE INVENTION

There are two major choices here for placing a TV or other electronic display; wall-mounting and stand-mounting.

Stand-mounting is the easiest and quickest way to set up a TV or other electronic display, stand mounting or table mounting involves putting the TV or other electronic display on a flat surface. This is usually a TV stand or table of moderate height, which will raise the TV or other electronic display to a reasonable level for you to watch. Most flat-screen TVs today—whether LED, OLED or Plasma—come with a base stand, which holds the TV or other electronic display upright and steady. This can either be a wide base with a single stem, or legs on either end of the bottom.

Stand-mounting has several disadvantages, the biggest of which is that the TV or other electronic display occupies surface space. A table-top or other flat surface is needed to place the TV or other electronic display on, and it would need to be wide enough for the TV or other electronic display's base stand. Often, the base stand or legs may be too wide, and will not fit easily on the existing table. Furthermore, the viewing height is dependent on the height of the stand, and a lack of height there may have the TV or other electronic display too low for many peoples' liking.

Another big disadvantage is the safety of the TV or other electronic display, as well as that of children and pets in a home. The TV or other electronic display is not attached to anything and simply rests steadily atop a flat surface. It can therefore easily tip over and fall with even a small accidental push, which could damage the TV or other electronic display itself or hurt someone.

Wall mounting is attaching a TV or other electronic display directly to a wall. Whether in a living room or bedroom, the TV or other electronic display can be placed on a wall across from seating, allowing viewing from a convenient position.

Wall mounting is not quite as easy as stand mounting and requires a bit of effort on the part of the user to attach the mount to the wall and the TV or other electronic display to the mount. For individuals who are not comfortable with the use of tools or drilling holes to attach screws yourself, they may have to depend on professionals to install the wall mount and TV or other electronic display for them or often risk damaging the TV or other electronic display in the process.

The biggest advantage of wall mounting a TV or other electronic display is the space it saves. In addition to saving space, when wall mounting a TV or other display one can choose exactly how high on the wall to mount the TV or other electronic display. Wall mounting also negates the problem of size; one no longer needs to worry about the TV or other electronic display fitting in the space they have, as long as your wall is large enough for the TV or other electronic display.

While most TVs or other electronic displays today come with the option to wall mount, with a basic low-profile mount usually included in the box. These are often complex and overly difficult for the typical homeowner or may require more wall intrusion desired or allowable.

Therefore, what is needed is a simple invention that enables the hanging of a TV that is familiar to a typical homeowner or adults that uses common components in a novel and non-obvious manner to provide such a solution at a low cost.

### SUMMARY OF THE INVENTION

The proposed invention is a device for hanging a TV, display screen, or other electronic display. The present invention is comprised of three components, a wire, one or more wire crimps, and one or more wire ring terminals.

The three components are combined to create a device for hanging a TV, display screen, or other electronic display. The device is created providing or cutting a 1.5 mm wire to a desired length or using one or more crimps to loop a wire into a desired length. Next a ring terminal is crimped on to each opposing end of the 1.5 mm wire.

Ring terminals are sized to fit the bolts and horizontal length of the mounting holes on the back of a TV, display screen, or other electronic display.

A length of wire longer than the horizontal distance between two points on the back of a TV, display screen, or other electronic display is used to create a partial loop, similar to that as used in hanging a picture. Ring terminal ends are sized to self-tapping screws or screws provided by the case or manufacturer mounts are used to attach the ring terminals and the associated wire to the TV, display screen, or other electronic display for hanging on a single hook, screw, or other receiving appending on a wall.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIG. 1 is an image of a prototype of the device of the present invention for hanging a TV, display screen, or other electronic display.

FIG. 2 is an example of the wire taught for use in combination with other components in a novel and non-obvious combination of other components which make up the present invention.

FIG. 3 is an example of the wire crimps taught for use in combination with other components in a novel and non-obvious combination of other components which make up the present invention.

FIG. 4 is an example of the ring terminals for use in combination with other components in a novel and non-obvious combination of other components which make up the present invention.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

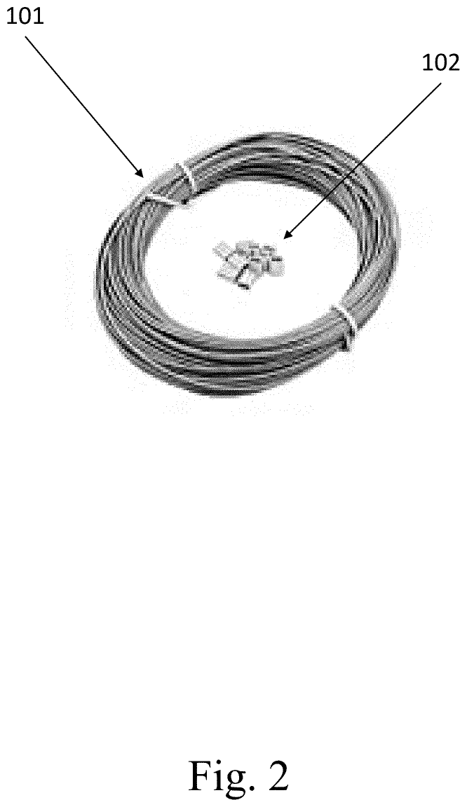

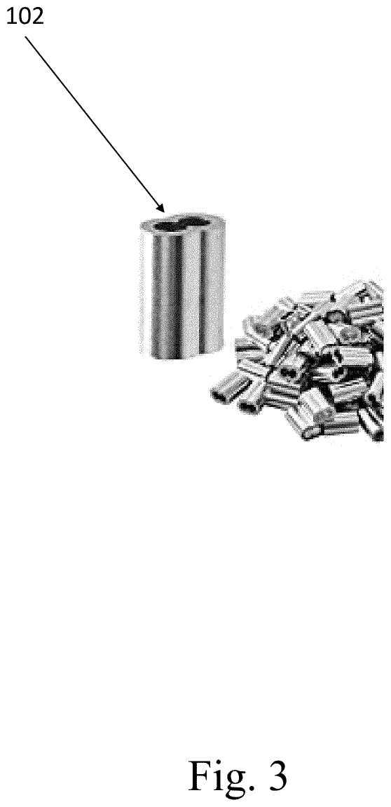

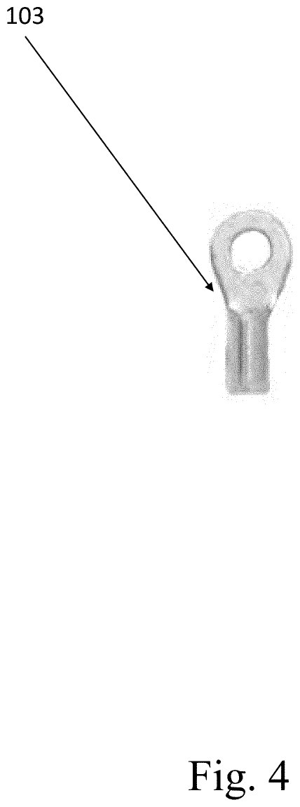

The proposed invention is a device for hanging a TV, display screen, or other electronic display. The present invention is comprised of three components, a wire 101 as shown in FIG. 2, one or more wire crimps 102 as shown in FIG. 3, and one or more wire ring terminals 103 as shown in FIG. 4.

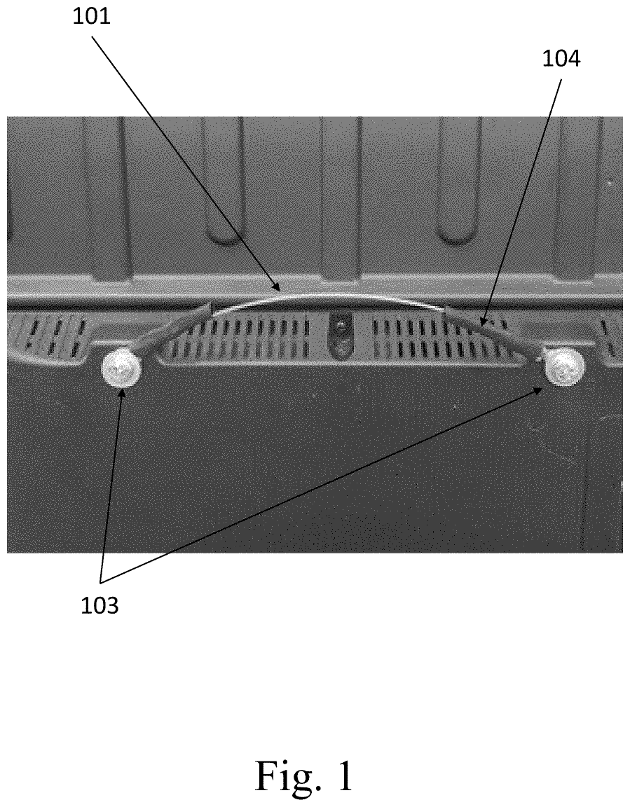

The three components are combined to create a device for hanging a TV, display screen, or other electronic display. As shown in FIG. 1, the device is created providing or cutting a 1.5 mm wire 101 to a desired length or using one or more crimps 102 to loop a wire into a desired length. Next a ring terminal 103 is crimped on to each opposing end of the 1.5 mm wire 101.

Ring terminals 103 are sized to fit the bolts and horizontal length of the mounting holes on the back of a TV, display screen, or other electronic display.

As shown in the prototype image of the invention of FIG. 1, a length of wire 101 longer than the horizontal distance between two points on the back of a TV, display screen, or other electronic display is used to create a partial loop, similar to that as used in hanging a picture. Ring terminal ends 103 are sized to self-tapping screws or screws provided by the case or manufacturer mounts are used to attach the ring terminals 103 and the associated wire 101 to the TV, display screen, or other electronic display for hanging on a single hook, screw, or other receiving appending on a wall.

In an alternative embodiment, shrink wrap tubing 104 is used in combination with the device to provide coverage for the wire ends as shown in FIG. 1. Here, the shrink wrap tubing 104 is used to cover and reduce the risk of injury to a user, which could occur when coming into contact with the sharp ends of the wire 101. A length of shrink wrap tubing 104 is applied to each end of the wire 101, securing a wire end section to a middle wire section and enclosing the wire ends providing a protective covering.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A device for hanging a TV, display screen, or other electronic display, consisting of:
a length of wire;
two ring terminals; and
a ring terminal is crimped on to the end of each end of the length of wire.

2. The device of claim 1, wherein
the wire is a 1.5 mm wire.

3. The device of claim 1, further comprising
providing wire of a desired length.

4. The device of claim 1, further comprising
cutting the wire to a desired length.

5. The device of claim 1, further comprising
one or more crimps, and
using one or more crimps to loop a wire into a desired length.

6. The device of claim 1, wherein
the ring terminals are sized to fit the bolts and horizontal length of the mounting holes on the back of a TV, display screen, or other electronic display.

7. The device of claim 1, wherein
the length of wire is longer than the horizontal distance between two points on the back of a TV, display screen, or other electronic display is used to create a partial loop, similar to that as used in hanging a picture.

8. The device of claim 1, wherein
ring terminal ends are sized to self-tapping screws; and
self-tapping screws are used to attach the ring terminals and the associated wire to the TV, display screen, or other electronic display for hanging on a single hook, screw, or other receiving appending on a wall.

9. The device of claim 1, wherein
ring terminal ends are sized to screws provided by the case or manufacturer mounts; and
the screws are used to attach the ring terminals and the associated wire to the TV, display screen, or other electronic display for hanging on a single hook, screw, or other receiving appending on a wall.

10. The device of claim 1, further comprising
one or more lengths of shrink wrap tubing;
applying a length of shrink wrap tubing to each end of the wire,
securing a wire end section to a middle wire section, and
enclosing the wire ends.
